(19) United States
(12) Patent Application Publication
(10) Pub. No.: US 2009/0294713 A1
(43) Pub. Date: Dec. 3, 2009

(54) Flow rate control valve

(75) Inventors: Takao HARADA, Tokyo (JP); Masaharu ITOH, Tokyo (JP); Yoshinori UCHIDA, Tokyo (JP)

Correspondence Address: BACON & THOMAS, PLLC, 625 SLATERS LANE, FOURTH FLOOR, ALEXANDRIA, VA, 22314-1176, US

(73) Assignee: FUJIKOKI CORPORATION, Tokyo (JP)

(21) Appl. No.: 12/385,644

(22) Filed: Apr. 15, 2009

(30) Foreign Application Priority Data
May 29, 2008 (JP) 2008-140710

(51) Int. Cl. F16K 31/02

(52) U.S. Cl. 251/129.15

(57) ABSTRACT

For stable use in a marine container, a flow rate control valve (1) is provided with a valve main body (4) having a valve chamber (2) and a valve hole (2a) in the valve chamber, a valve body (3) for opening and closing the valve hole, a can (7) protruding from the valve main body, a drive mechanism (5) provided in the can to drive the valve body in opening and closing directions, a coil mold body (6) installed to an outer peripheral portion of the can to generate electromagnetic force for the drive mechanism, a tubular portion (8) protruding downward from the coil mold body and surrounding a part of the valve main body or the can, and seal means (9, 10) for sealing a gap between an outer peripheral surface of the valve main body or the can and an inner peripheral surface of the tubular portion.

### BACKGROUND OF THE INVENTION

1. Field of the Invention

The present invention relates to a flow rate control valve which is used for controlling a refrigerant flow rate of a refrigerating cycle and carries out an opening and closing operation of a valve body on the basis of electromagnetic force.

2. Description of the Conventional Art

As one example of the flow rate control valve, a flow rate control valve described in Japanese Unexamined Patent Publication No. 2005-42891 is constructed by a valve main body 54 having a valve chamber 52 and a valve hole 52a formed in the valve chamber 52, a valve body 53 for opening and closing the valve hole 52a, and a drive mechanism 59 provided in an inner portion of a can 57 protruding upward from the valve main body 54, and controls a fluid such as a refrigerant or the like by driving the valve body 53 in vertical directions.

The driving of the valve body 53 by the drive mechanism 59 is carried out by a stepping motor constructed by a rotor 56 provided in the inner portion of the can 57, and a stator 58 outside fitted to the can 57, and the stator 58 is provided with a coil 58b wound around a bobbin 58a, and is molded by a resin.

### SUMMARY OF THE INVENTION

### Problem to be Solved by the Invention

As mentioned above, since the conventional flow rate control valve 51 is structured such that the coil 58b of the stator 58 is molded by a resin, and magnetic poles of the stator 58 is exposed but rust proofed, a countermeasure is made against corrosion. However, in the case that the flow rate control valve 51 as mentioned above is used in a marine container or the like, each of portions is corroded by salt damage, and there is a risk that a malfunction is caused.

Accordingly, the present invention is made by taking into consideration the problem in the conventional flow rate control valve mentioned above, and an object of the present invention is to provide a flow rate control valve which can maintain a stable operation even in the case of being used in a marine container or the like.

### Means for Solving the Problem

In order to achieve the object mentioned above, in accordance with the present invention, there is provided a flow rate control valve comprising:

a valve main body for having a valve chamber and a valve hole formed in the valve chamber;

a valve body opening and closing the valve hole;

a can protruding from the valve main body;

a drive mechanism provided in an inner portion of the can to drive the valve body in opening and closing directions;

a coil mold body installed to an outer peripheral portion of the can to generate electromagnetic force for driving the drive mechanism;

a tubular portion protruding from the coil mold body toward an opposite direction to the protruding direction of the can and surrounding a part of the valve main body or the can; and

a seal means for sealing a gap between an outer peripheral surface of the valve main body or the can and an inner peripheral surface of the tubular portion.

Further, in accordance with the present invention, since a part of the valve main body or the can is surrounded by the tubular body protruding from the coil mold body toward the opposite direction to the protruding direction of the can, and the gap between the outer peripheral surface of the valve main body or the can and the inner peripheral surface of the tubular portion is sealed by the seal means, it is possible to shield the coil, magnetic poles and the like of the stator from an external environment. Even in the case that the flow rate control valve in accordance with the present invention is used in the marine container or the like, the coil or the like is hard to be corroded by salt damage, and it is possible to maintain a stable operation.

In the flow rate control valve mentioned above, the tubular portion may be integrally formed with the coil mold body. Further, the tubular portion may be formed independently from the coil mold body so as to be welded to the resin which constructs the coil mold body, or may be simultaneously fixed to the coil mold body at a time of filling of the resin when the coil mold body is formed.

Further, in the flow rate control valve mentioned above, the seal means may be constructed by at least one O-ring which is installed to the gap between the outer peripheral surface of the valve main body or the can and the inner peripheral surface of the tubular portion. It is possible to replace the stator coil at a work site where the flow rate control valve is attached, as well as a workability for assembling the flow rate control valve is improved, by using the O-ring, and it is possible to further improve a sealing performance by increasing an installing number of the O-ring.

Further, the seal means may be constructed by a resin filled in the gap between the outer peripheral surface of the valve main body or the can and the inner peripheral surface of the tubular portion. Accordingly, since the stator is completely fixed to the valve main body, a rotation stopper of the stator to the valve main body is not necessary.

### EFFECT OF THE INVENTION

As mentioned above, in accordance with the present invention, it is possible to provide a flow rate control valve in which a coil or the like is hard to be corroded by salt damage so as to maintain a stable operation, even in the case of being used in a marine container or the like.

### BRIEF EXPLANATION OF DRAWINGS

FIG. 1 is a sectional view showing an embodiment of a flow rate control valve in accordance with the present invention; and

FIG. 2 is a sectional view showing an embodiment of a conventional flow rate control valve.

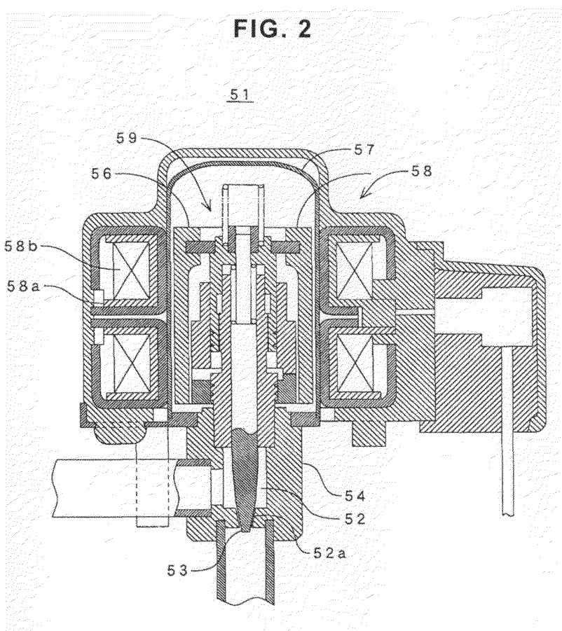

### DETAILED DESCRIPTION OF PREFERRED EMBODIMENT

Next, a description will be given of an embodiment in accordance with the present invention with reference to the accompanying drawings.

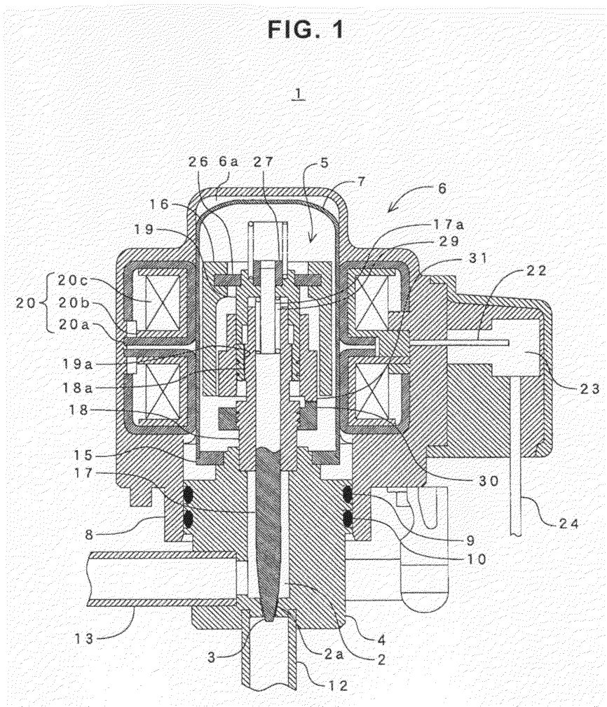

FIG. 1 shows an embodiment of a flow rate control valve in accordance with the present invention, and the flow rate control valve 1 is provided with a valve main body 4 having a valve chamber 2 and a valve hole 2a formed in the valve chamber 2, a valve body 3 for opening and closing the valve hole 2a, a can 7 protruding upward from the valve main body 4, a drive mechanism 5 provided in an inner portion of the can 7 and driving the valve body 3 in an opening and closing direction (a vertical direction), a coil mold body 6 installed to an outer peripheral portion of the can 7 to generate electromagnetic force for driving the drive mechanism 5, a tubular portion (a skirt-shaped portion) 8 protruding downward from the coil mold body 6 and surrounding an outer peripheral surface of the valve main body 4, and two O-rings 9 and 10 for serving as a seal means to seal a gap between the outer peripheral surface of the valve main body 4 and an inner peripheral surface of the tubular portion 8.

Fluid outflow and inflow pipes 12 and 13 are coupled to a lower portion and a side portion of the valve main body 4 so as to communicate with the valve chamber 2. A valve hole 2a is provided in the valve chamber 2 within the valve main body 4, and a flow rate of fluid is controlled by a gap between the valve hole 2a and the valve body 3.

A lower end portion of the closed-end cylindrical can 7 is butt welded to a step portion of a collar-like plate 15 firmly attached by caulking to the valve main body 4, and a rotor (a permanent magnet) 16, a valve shaft 17, a male screw pipe 18, a valve shaft holder 19 and the like are arranged as the drive mechanism for driving the valve main body 3 in the vertical direction, in an inner portion of the can 7.

The rotor 16 is coupled to a valve shaft holder 19 via a stop ring 26. An upper protruding portion of the valve shaft holder 19 is fitted to an inner peripheral hole portion of the stop ring 26, and the rotor 16, the stop ring 26 and the valve shaft holder 19 are integrally coupled by caulking and fixing an outer periphery of the protruding portion.

The valve shaft holder 19 is formed in a below-opened cylindrical shape so as to be positioned at an outer side of the male screw pipe 18, and a female screw portion 19a for engaging with a male screw portion 18a of the male screw pipe 18 is provided on an inner peripheral surface thereof. An upper reduced diameter portion 17a formed via a step portion of the valve shaft 17 is fitted to an upper portion of the valve shaft holder 19 so as to be coupled by a push nut 27.

The valve shaft 17 is provided with the valve body 3 at its lower end portion, and is fitly inserted to a center of the valve shaft holder 19 so as to be movable up and down. The valve shaft 17 is always energized downward by a compression coil spring 29 provided in a state of compression within the valve shaft holder 19.

The male screw pipe 18 is provided with the male screw portion 18a on its outer peripheral surface, and a lower stopper body 30 constructing one part of a stopper mechanism is firmly attached to the male screw pipe 18. On the other hand, an upper stopper body 31 constructing the other part of the stopper mechanism is firmly attached to the valve shaft holder 19, and is structured such as to be contactable with the lower stopper body 30.

The coil mold body 6 is installed to an outer peripheral portion of the can 7 via the fitting hole 6a. The coil mold body 6 is provided with a stator 20, the stator 20 is structured by arrangement of a yoke 20a which is constructed by a magnetic material, and a coil 20c which is wound around the yoke 20a via a bobbin 20b, at two stages of up per and lower sides, and a stepping motor is constructed by the stator 20 and the rotor 16.

The tubular portion 8 protrudes downward at a lower portion of the coil mold body 6, and surrounds an outer peripheral surface of the valve main body 4. The tubular portion 8 is formed at the same time of sealing of the stator 20 by resin, and constructs a part of the coil mold body 6. The O-rings 9 and 10 are installed between the inner peripheral surface of the tubular portion 8 and the outer peripheral surface of the valve main body 4, the coil 20c and the magnetic poles of the stator 20 are shielded from an external environment by the tubular portion 8 and the O-rings 9 and 10, and it is possible to prevent the coil 20c and the like from being corroded by salt damage, even in the case that the flow rate control valve 1 is used in a marine container or the like.

Further, a plurality of lead terminals 22 connected to the coil 20c of the stator 20 protrude from the coil mold body 6, a connector 23 is coupled to the lead terminal 22, and a plurality of lead wires 24 are connected to the connector 23.

The flow rate control valve 1 made as mentioned above is structured such that the rotor 16 is rotated when an electric current is applied to the coil 20c in one direction so as to excite it, and the valve shaft holder 19 is rotated relatively with respect to the male screw pipe 18 accordingly. In this case, since the lower portion of the male screw pipe 18 is fixed to the valve main body 4, for example, the valve shaft holder 19 is moved downward by a screw feed mechanism constituted by the male screw portion 18a of the male screw pipe 18 and the female screw portion 19a of the valve shaft holder 19. Accordingly, the valve shaft 17 is moved downward, and the valve body 3 closes the valve hole 2a. In this case, since the lower stopper body 30 and the upper stopper body 31 of the stopper mechanism come into contact, a further downward movement of the valve body 3 is limited.

Next, when the coil 20c is excited by applying of an electric current in the other direction, the rotor 16 is relatively rotated in a reverse direction to that mentioned above with respect to the male screw pipe 18 firmly attached to the valve main body 4, the valve shaft holder 19 is moved upward by the screw feed mechanism, and the valve body 3 at a lower end of the valve shaft 17 is moved upward so as to open the valve hole 2a.

Since the flow rate control valve 1 having the structure mentioned above is made such that the outer peripheral surface of the valve main body 4 surrounded by the tubular portion 8 protruding in an opposite direction to the protruding direction of the can 7, that is, downward from the coil mold body 6, and the gap between the inner peripheral surface of the tubular portion 8 and the outer peripheral surface of the valve main body 4 is sealed by the O-rings 9 and 10 as mentioned above, it is possible to shield the coil 20c and the magnetic poles of the stator 20 from the external environment, the coil 20c and the like are hard to be corroded by salt damage even in the case of being used in the marine container or the like, and it is possible to maintain the stable operation of the flow rate control valve 1.

In this case of the embodiment mentioned above, the outer peripheral surface of the valve main body 4 is surrounded by the tubular portion 8, and the gap between the inner peripheral surface of the tubular portion 8 and the outer peripheral surface of the valve main body 4 is sealed by the O-rings 9 and 10, however, the structure may be made such as to shield the coil 20c and the magnetic poles of the stator 20 from the external environment by surrounding the outer peripheral surface of the can 7 by the tubular portion 8, and sealing the gap between the inner peripheral surface of the tubular portion 8 and the can 7.

Further, in the embodiment mentioned above, the O-rings 9 and 10 are fitted to the ring groove of the outer peripheral surface of the valve main body 4, and the inner peripheral surface of the tubular portion 8 is formed as a smooth surface, however, the structure maybe reversely made such that a ring groove is provided on an inner peripheral surface of the tubular portion 8, the O-ring 9 is fitted thereto, and the outer peripheral surface of the valve main body 4 or the can 7 is formed as a smooth surface.

Further, in the embodiment mentioned above, the tubular portion 8 is formed integrally with the coil mold body 6, however, the tubular portion 8 may be formed independently from the coil mold body 6 so as to be welded to the resin which constructs the coil mold body 6. Further, the tubular portion 8 may be simultaneously fixed to the coil mold body 6 at a time of filling of the resin when the coil mold body 6 is formed.

Further, while the gap between the inner peripheral surface of the tubular portion 8 and the outer peripheral surface of the valve main body 4 is sealed by the O-rings 9 and 10, the number of the O-rings is not limited to two, but may be set to one or three or more. Further, instead of the O-ring, it is possible to seal between both the elements by filling of a resin in the gap between the inner peripheral surface of the tubular portion 8 and the outer peripheral surface of the valve main body 4.

Further, in the embodiment mentioned above, the description is given of the example which is applied to a so-called motor-driven valve in which the drive mechanism 5 of the flow rate control valve 1 is driven by the stepping motor, however, the present invention can be applied to a so-called electromagnetic valve in which the drive mechanism 5 is driven by a plunger and a suction element.

What is claimed is:

1. A flow rate control valve comprising:
a valve main body having a valve chamber and a valve hole formed in said valve chamber;
a valve body for opening and closing said valve hole;
a can protruding from said valve main body;
a drive mechanism provided in an inner portion of said can to drive said valve body in opening and closing directions;
a coil mold body installed to an outer peripheral portion of said can to generate electromagnetic force for driving said drive mechanism;
a tubular portion protruding from said coil mold body toward an opposite direction to the protruding direction of said can and surrounding a part of said valve main body or said can; and
a seal means for sealing a gap between an outer peripheral surface of said valve main body or said can and an inner peripheral surface of said tubular portion.

2. A flow rate control valve as claimed in claim 1, wherein said tubular portion is integrally formed with said coil mold body.

3. A flow rate control valve as claimed in claim 1, wherein said tubular portion is formed independently from said coil mold body so as to be welded to the resin which constructs said coil mold body, or simultaneously fixed to said coil mold body at a time of filling of the resin when said coil mold body is formed.

4. A flow rate control valve as claimed in claim 1, wherein said seal means is constructed by at least one O-ring which is installed to the gap between the outer peripheral surface of said valve main body or said can and the inner peripheral surface of said tubular portion.

5. A flow rate control valve as claimed in claim 2, wherein said seal means is constructed by at least one O-ring which is installed to the gap between the outer peripheral surface of said valve main body or said can and the inner peripheral surface of said tubular portion.

6. A flow rate control valve as claimed in claim 3, wherein said seal means is constructed by at least one O-ring which is installed to the gap between the outer peripheral surface of said valve main body or said can and the inner peripheral surface of said tubular portion.

7. A flow rate control valve as claimed in claim 1, wherein said seal means is constructed by a resin filled in the gap between the outer peripheral surface of said valve main body or said can and the inner peripheral surface of said tubular portion.

8. A flow rate control valve as claimed in claim 2, wherein said seal means is constructed by a resin filled in the gap between the outer peripheral surface of said valve main body or said can and the inner peripheral surface of said tubular portion.

9. A flow rate control valve as claimed in claim 3, wherein said seal means is constructed by a resin filled in the gap between the outer peripheral surface of said valve main body or said can and the inner peripheral surface of said tubular portion.
